(19) United States
(12) Patent Application Publication
(10) Pub. No.: US 2019/0289707 A1
(43) Pub. Date: Sep. 19, 2019

(54) EXTREME ULTRAVIOLET LIGHT GENERATION SYSTEM

(71) Applicant: Gigaphoton Inc., Tochigi (JP)

(72) Inventors: Yuichi NISHIMURA, Oyama-shi (JP); Takayuki YABU, Oyama-shi (JP); Yoshifumi UENO, Oyama-shi (JP)

(73) Assignee: Gigaphoton Inc., Tochigi (JP)

(21) Appl. No.: 16/434,197

(22) Filed: Jun. 7, 2019

Related U.S. Application Data
(63) Continuation of application No. PCT/JP2017/001106, filed on Jan. 13, 2017.

(51) Int. Cl. H05G 2/00; G02B 26/08

(52) U.S. Cl. CPC H05G 2/008; G02B 26/0816

(57) ABSTRACT

An EUV light generation system includes: a target supply unit; a prepulse laser that outputs a prepulse laser beam; a main pulse laser that outputs a main pulse laser; a light focusing optical system that focuses the prepulse and main pulse laser beams on a predetermined region; an actuator that changes a focusing position of the prepulse laser beam by the light focusing optical system; a first sensor that captures an image of a target; and a control unit that stores a reference position of the actuator, calculates a predetermined parameter on the target after irradiation with the prepulse laser beam and before irradiation with the main pulse laser beam based on image data obtained from the first sensor, and controls the actuator to approach the reference position if the predetermined parameter does not satisfy a first condition.

### CROSS-REFERENCE TO RELATED APPLICATIONS

The present application is a continuation application of International Application No. PCT/JP 2017/001106 filed on Jan. 13, 2017. The content of the application is incorporated herein by reference in its entirety.

### BACKGROUND

### 1. Technical Field

The present disclosure relates to an extreme ultraviolet light generation system.

### 2. Related Art

Recently, miniaturization of semiconductor processes has involved rapidly increasing miniaturization of transfer patterns for use in photolithography of the semiconductor processes. In the next generation, microfabrication at 70 nm to 45 nm and further microfabrication at 32 nm or less will be required. Thus, to satisfy the requirement for the microfabrication at 32 nm or less, development of an exposure apparatus is expected including a combination of an extreme ultraviolet light generation apparatus configured to generate extreme ultraviolet (EUV) light having a wavelength of about 13 nm and reduced projection reflection optics.

Three types of EUV light generation apparatuses have been proposed: an LPP (Laser Produced Plasma) type apparatus using plasma generated by irradiating a target substance with a pulse laser beam, a DPP (Discharge Produced Plasma) type apparatus using plasma generated by discharge, and an SR (Synchrotron Radiation) type apparatus using synchrotron radiation.

### LIST OF DOCUMENTS

### Patent Documents

Patent Document 1: International Patent Publication No. 2016/063409

### SUMMARY

An extreme ultraviolet light generation system according to an aspect of the present disclosure includes: a target supply unit configured to output a target toward a predetermined region; a prepulse laser configured to output a prepulse laser beam to be applied to the target in the predetermined region; a main pulse laser configured to output a main pulse laser beam to be applied to the target irradiated with the prepulse laser beam in the predetermined region; a light focusing optical system configured to focus the prepulse laser beam and the main pulse laser beam on the predetermined region; an actuator configured to change a focusing position of the prepulse laser beam by the light focusing optical system; a first sensor configured to capture an image of the target after irradiation with the prepulse laser beam and before irradiation with the main pulse laser beam; and a control unit configured to store a reference position of the actuator, calculate a predetermined parameter on the target after irradiation with the prepulse laser beam and before irradiation with the main pulse laser beam based on image data obtained from the first sensor, and control the actuator to approach the reference position if the predetermined parameter does not satisfy a first condition.

An extreme ultraviolet light generation system according to another aspect of the present disclosure includes: a target supply unit configured to output a target toward a predetermined region; a prepulse laser configured to output a prepulse laser beam to be applied to the target in the predetermined region; a main pulse laser configured to output a main pulse laser beam to be applied to the target irradiated with the prepulse laser beam in the predetermined region; a light focusing optical system configured to focus the prepulse laser beam and the main pulse laser beam on the predetermined region; an actuator configured to change a focusing position of the prepulse laser beam by the light focusing optical system; a second sensor configured to detect light radiated from the predetermined region after the target is irradiated with the main pulse laser beam; and a control unit configured to store a reference position of the actuator, obtain a predetermined parameter, control the actuator based on data obtained from the second sensor if the predetermined parameter satisfies a first condition, and control the actuator based on the reference position if the predetermined parameter does not satisfy the first condition.

### BRIEF DESCRIPTION OF THE DRAWINGS

With reference to the accompanying drawings, some embodiments of the present disclosure will be described below merely by way of example.

FIG. 1 schematically shows a configuration of an exemplary LPP type EUV light generation system.

FIG. 2 is a partial sectional view of a configuration of an EUV light generation system 11a according to a comparative example.

FIG. 3 is a partial sectional view of the configuration of the EUV light generation system 11a according to the comparative example.

FIG. 4 is a partial sectional view of a configuration of an EUV light generation system lib according to a first embodiment of the present disclosure.

FIG. 5 is a partial sectional view of an exemplary configuration of a mist sensor 80.

FIGS. 6A to 6I illustrate a principle of estimating a deviation of a focusing position of a first prepulse laser beam 31fp based on an image of a target immediately after irradiation with the first prepulse laser beam 31fp.

FIG. 7 is a flowchart of a procedure of an optical path axis adjustment in the first embodiment.

FIG. 8 is a flowchart of detailed processing of controlling an actuator based on outputs of EUV light sensors 70c to 70e in the first embodiment.

FIG. 9 is a flowchart of a procedure of an optical path axis adjustment in a second embodiment of the present disclosure.

FIG. 10 is a partial sectional view of a configuration of an EUV light generation system 11c according to a third embodiment of the present disclosure.

FIG. 11 is a flowchart of detailed processing of controlling an actuator based on outputs of EUV light sensors 70c to 70e in the third embodiment.

### DESCRIPTION OF EMBODIMENTS

### <Contents>

1. General description of extreme ultraviolet light generation system

1.1 Configuration

1.2 Operation

2. EUV light generation system according to comparative example

2.1 Configuration

2.1.1 Target supply unit

2.1.2 Laser apparatus

2.1.3 Laser beam traveling direction control unit

2.1.4 Laser beam focusing optical system and EUV focusing mirror

2.1.5 EUV light sensor

2.2 Operation

2.2.1 Output of target

2.2.2 Output of pulse laser beam

2.2.3 Transmission of pulse laser beam

2.2.4 Focusing of pulse laser beam

2.2.5 Detection of EUV gravity center position

2.3 Problem

3. EUV light generation system including mist sensor 80

3.1 Configuration

3.2 Operation

3.2.1 Main flow

3.2.2 Control of actuator based on outputs of EUV light sensors

3.3 Effect

4. EUV light generation system configured to determine first and second conditions based on inclination of secondary target

4.1 Main flow

4.2 Effect

5. EUV light generation system configured to control mirror actuator 411

5.1 Configuration

5.2 Operation

5.2.1 Control of actuator based on outputs of EUV light sensors

5.3 Effect

### 6. Supplementation

Now, with reference to the drawings, embodiments of the present disclosure will be described in detail. The embodiments described below illustrate some examples of the present disclosure, and do not limit contents of the present disclosure. Also, all configurations and operations described in the embodiments are not necessarily essential as configurations and operations of the present disclosure. Like components are denoted by like reference numerals, and overlapping descriptions are omitted.

### 1. General Description of Extreme Ultraviolet Light Generation System

1.1 Configuration

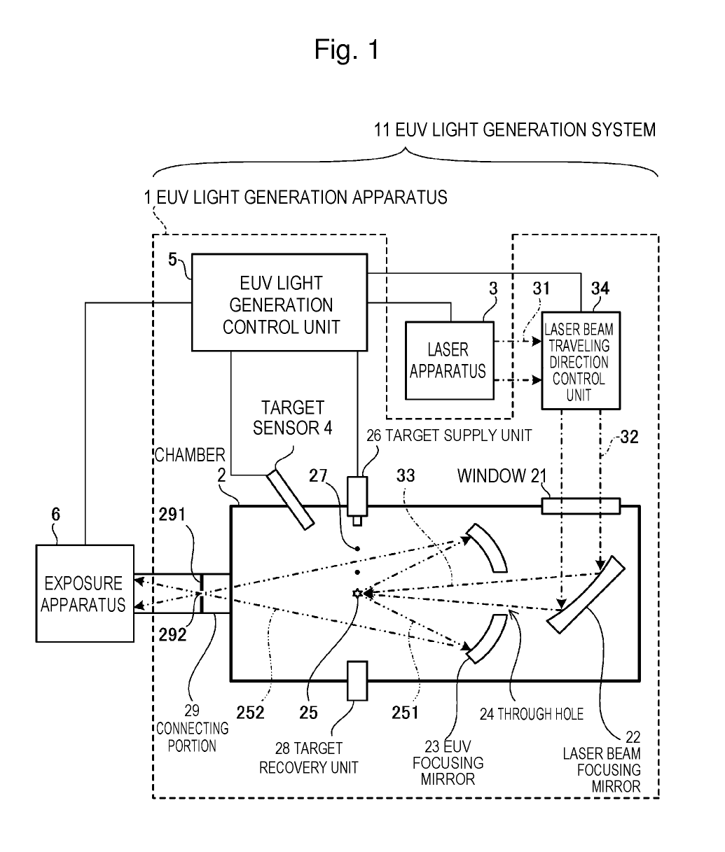

FIG. 1 schematically shows a configuration of an exemplary LPP type EUV light generation system. An EUV light generation apparatus 1 is used together with at least one laser apparatus 3. In this application, a system including the EUV light generation apparatus 1 and the laser apparatus 3 is referred to as an EUV light generation system 11. As shown in FIG. 1 and described below in detail, the EUV light generation apparatus 1 includes a chamber 2 and a target supply unit 26. The chamber 2 is configured to be sealable. The target supply unit 26 is mounted, for example, to extend through a wall of the chamber 2. A material of a target substance output from the target supply unit 26 may include tin, terbium, gadolinium, lithium, xenon, or any combinations of two or more of them, but not limited to them.

The wall of the chamber 2 has at least one through hole. A window 21 is provided in the through hole. A pulse laser beam 32 output from the laser apparatus 3 passes through the window 21. In the chamber 2, an EUV focusing mirror 23 having, for example, a spheroidal reflection surface is arranged. The EUV focusing mirror 23 has first and second focal points. On a surface of the EUV focusing mirror 23, a multilayer reflective film including, for example, alternately stacked molybdenum and silicon is formed. The EUV focusing mirror 23 is arranged so that, for example, the first focal point is located in a plasma generation region 25 and the second focal point is located in an intermediate focal (IF) point 292. A through hole 24 is provided in a center of the EUV focusing mirror 23. A pulse laser beam 33 passes through the through hole 24.

The EUV light generation apparatus 1 includes an EUV light generation control unit 5, a target sensor 4, and the like. The target sensor 4 has an imaging function, and is configured to detect presence, a trajectory, a position, a speed, or the like of a target 27.

The EUV light generation apparatus 1 includes a connecting portion 29 configured to provide communication between an interior of the chamber 2 and an interior of an exposure apparatus 6. In the connecting portion 29, a wall 291 having an aperture is provided. The wall 291 is arranged so that the aperture is located in a second focal position of the EUV focusing mirror 23.

Further, the EUV light generation apparatus 1 includes a laser beam traveling direction control unit 34, a laser beam focusing mirror 22, a target recovery unit 28 for recovering the target 27, and the like. The laser beam traveling direction control unit 34 includes an optical element for defining a traveling direction of a laser beam, and an actuator for adjusting a position, an orientation, or the like of the optical element.

1.2 Operation

With reference to FIG. 1, a pulse laser beam 31 output from the laser apparatus 3 passes through the laser beam traveling direction control unit 34 and passes through the window 21 as the pulse laser beam 32, which enters the chamber 2. The pulse laser beam 32 travels along at least one laser beam path in the chamber 2, is reflected by the laser beam focusing mirror 22, and is applied as the pulse laser beam 33 to at least one target 27.

The target supply unit 26 outputs the target 27 toward the plasma generation region 25 in the chamber 2. The target 27 is irradiated with at least one pulse included in the pulse laser beam 33. The target 27 irradiated with the pulse laser beam is turned into plasma, and radiation light 251 is radiated from the plasma. The EUV focusing mirror 23 reflects EUV light included in the radiation light 251 with higher reflectance than light in a different wavelength region. Reflected light 252 including the EUV light reflected by the EUV focusing mirror 23 is focused on the intermediate focal point 292 and output to the exposure apparatus 6. One target 27 may be irradiated with a plurality of pulses included in the pulse laser beam 33.

The EUV light generation control unit 5 collectively controls the entire EUV light generation system 11. The EUV light generation control unit 5 processes image data or the like of the target 27 captured by the target sensor 4. Also, the EUV light generation control unit 5 controls, for example, output timing of the target 27, an output direction of the target 27, or the like. Further, the EUV light generation control unit 5 controls, for example, oscillation timing of the laser apparatus 3, a traveling direction of the pulse laser beam 32, a focusing position of the pulse laser beam 33, or the like. These various controls are mere examples, and other controls may be added as required.

### 2. EUV Light Generation System According to Comparative Example

2.1 Configuration

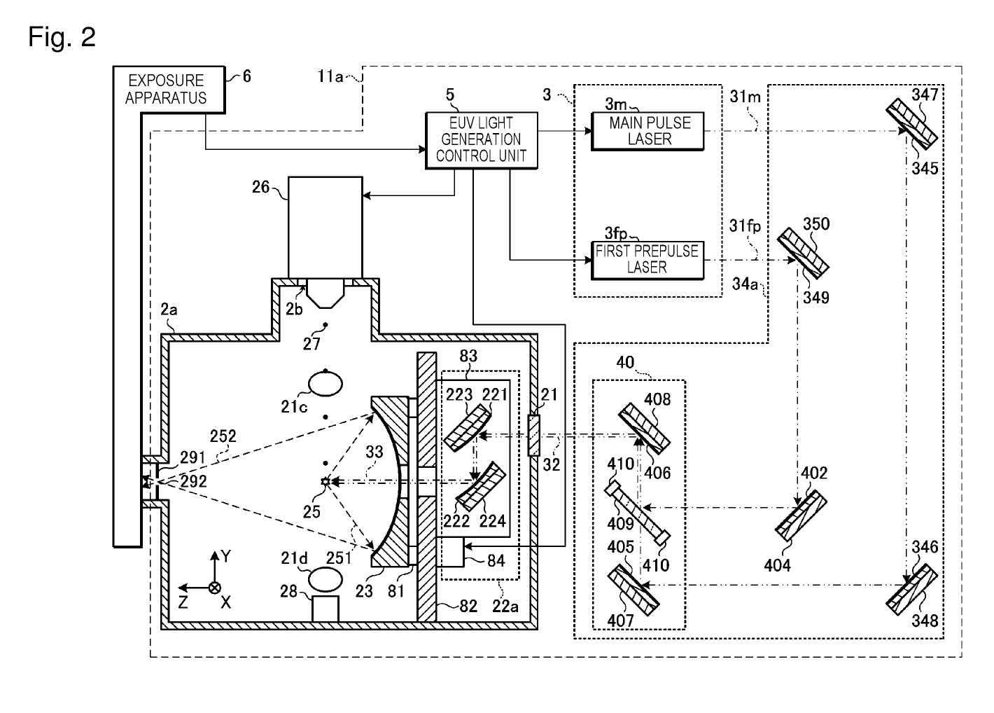

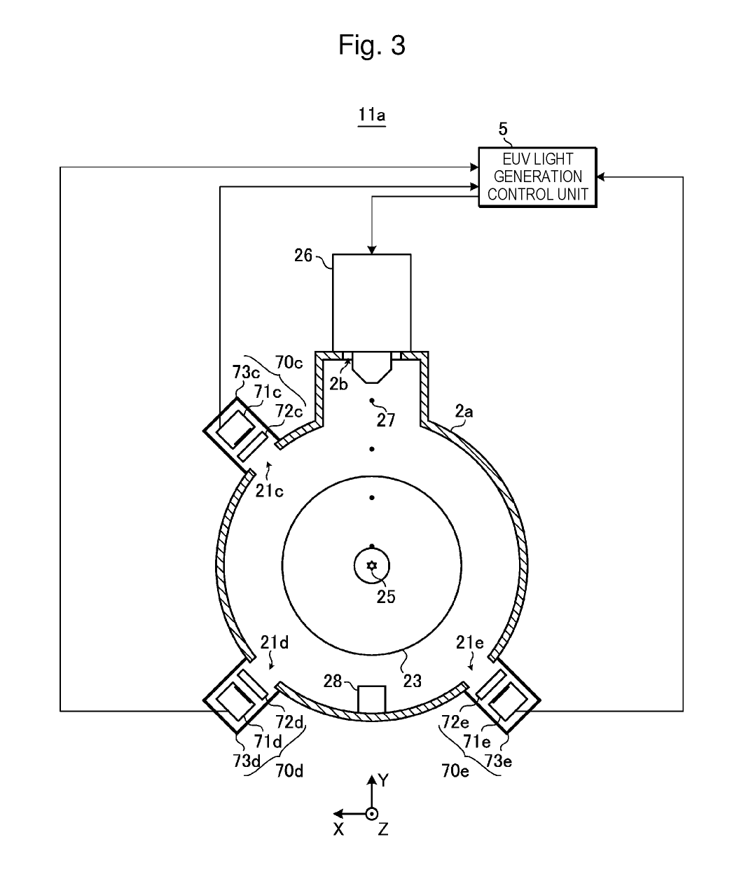

FIGS. 2 and 3 are partial sectional views of a configuration of an EUV light generation system 11a according to a comparative example. As shown in FIGS. 2 and 3, an output direction of EUV light is a Z direction. A direction opposite to an output direction of a target is a Y direction. A direction perpendicular to the Z direction and the Y direction is an X direction. FIG. 2 shows the EUV light generation system 11a seen in the X direction from a position in a −X direction. FIG. 3 shows the EUV light generation system 11a seen in a −Z direction from a position in the Z direction.

In the chamber 2a, a laser beam focusing optical system 22a, an EUV focusing mirror 23, a target recovery unit 28, an EUV focusing mirror holder 81, and plates 82, 83 are provided. A target supply unit 26 is mounted to the chamber 2a.

Outside the chamber 2a, a laser apparatus 3, a laser beam traveling direction control unit 34a, and an EUV light generation control unit 5 are provided. The EUV light generation control unit 5 includes a processor and a memory (not shown).

2.1.1 Target Supply Unit

The target supply unit 26 is arranged to extend through a through hole 2b formed in a wall surface of the chamber 2a. Sealing means (not shown) is arranged between the wall surface of the chamber 2a around the through hole 2b and the target supply unit 26. The sealing means seals between the wall surface of the chamber 2a around the through hole 2b and the target supply unit 26.

The target supply unit 26 holds a melted target material. The target supply unit 26 has an opening (not shown) located in the chamber 2a. A vibrating device (not shown) is arranged near the opening of the target supply unit 26.

The target supply unit 26 includes an XZ stage (not shown). The EUV light generation control unit 5 controls the XZ stage based on an output of a target sensor 4 described with reference to FIG. 1. Controlling the XZ stage can adjust a trajectory of a target 27 so that the target 27 passes through a plasma generation region 25.

2.1.2 Laser Apparatus

The laser apparatus 3 includes a first prepulse laser 3fp and a main pulse laser 3m. The first prepulse laser 3fp is configured to output a first prepulse laser beam 31fp. The main pulse laser 3m is configured to output a main pulse laser beam 31m. The first prepulse laser 3fp is constituted by, for example, a YAG laser apparatus or a laser apparatus using Nd:YVO₄. The main pulse laser 3m is constituted by, for example, a CO₂ laser apparatus. The first prepulse laser 3fp and the main pulse laser 3m each include a laser oscillator and, as required, a laser amplifier. The YAG laser apparatus uses a YAG crystal as a laser medium in one or both of the laser oscillator and the laser amplifier. The CO₂ laser apparatus uses a CO₂ gas as a laser medium in one or both of the laser oscillator and the laser amplifier.

2.1.3 Laser Beam Traveling Direction Control Unit

The laser beam traveling direction control unit 34a includes high reflection mirrors 349, 402. The high reflection mirrors 349, 402 are arranged in an optical path of the first prepulse laser beam 31fp. The high reflection mirror 349 is supported by a holder 350. The high reflection mirror 402 is supported by a holder 404. An actuator (not shown) may be mounted to each of the holders 350, 404.

The laser beam traveling direction control unit 34a further includes high reflection mirrors 345, 346. The high reflection mirrors 345, 346 are arranged in an optical path of the main pulse laser beam 31m. The high reflection mirror 345 is supported by a holder 347. The high reflection mirror 346 is supported by a holder 348. An actuator (not shown) may be mounted to each of the holders 347, 348.

The laser beam traveling direction control unit 34a further includes a beam combiner module 40. The beam combiner module 40 includes high reflection mirrors 405, 406 and a beam combiner 409.

The high reflection mirror 405 is arranged in an optical path of the main pulse laser beam 31m reflected by the high reflection mirror 346. The high reflection mirror 405 is supported by a holder 407.

The beam combiner 409 is located in an optical path of the first prepulse laser beam 31fp reflected by the high reflection mirror 402. The beam combiner 409 is located in an optical path of the main pulse laser beam 31m reflected by the high reflection mirror 405. The beam combiner 409 is supported by a holder 410. The beam combiner 409 is constituted by, for example, a dichroic mirror. The beam combiner 409 is configured to reflect the first prepulse laser beam 31fp with high reflectance and transmit the main pulse laser beam 31m with high transmittance. The beam combiner 409 is configured to substantially match optical path axes of the first prepulse laser beam 31fp and the main pulse laser beam 31m. The optical path axis refers to a central axis of an optical path.

The high reflection mirror 406 is arranged in optical paths of the first prepulse laser beam 31fp reflected by the beam combiner 409 and the main pulse laser beam 31m having passed through the beam combiner 409. The high reflection mirror 406 is supported by a holder 408. The high reflection mirror 406 is configured to reflect the first prepulse laser beam 31fp and the main pulse laser beam 31m inward of the chamber 2a. The first prepulse laser beam 31fp and the main pulse laser beam 31m reflected by the high reflection mirror 406 are herein sometimes collectively referred to as a pulse laser beam 32.

2.1.4 Laser Beam Focusing Optical System and EUV Focusing Mirror

The plate 82 is secured to the chamber 2a. The EUV focusing mirror 23 is secured to the plate 82 via the EUV focusing mirror holder 81.

The plate 82 supports the plate 83 and a laser beam focusing optical system actuator 84. The laser beam focusing optical system 22a includes an off-axis parabolic convex mirror 221 and an ellipsoidal concave mirror 222. The off-axis parabolic convex mirror 221 is supported by a holder 223. The ellipsoidal concave mirror 222 is supported by a holder 224. The holders 223, 224 are supported by the plate 83. The laser beam focusing optical system 22a corresponds to a light focusing optical system in the present disclosure.

The off-axis parabolic convex mirror 221 is a mirror having a convex surface of a paraboloid of revolution as a reflection surface. The off-axis parabolic convex mirror 221 is arranged so that an axis of the paraboloid of revolution is substantially parallel to an optical path axis of the pulse laser beam 32 entering the off-axis parabolic convex mirror 221.

The ellipsoidal concave mirror 222 is a mirror having a concave surface of a spheroid as a reflection surface. The ellipsoidal concave mirror 222 has first and second focal points. The ellipsoidal concave mirror 222 is arranged so that a focal point of the off-axis parabolic convex mirror 221 substantially matches the first focal point of the ellipsoidal concave mirror 222. The second focal point of the ellipsoidal concave mirror 222 is located in the plasma generation region 25.

2.1.5 EUV Light Sensor

As shown in FIG. 3, a plurality of EUV light sensors 70c to 70e are mounted to the wall surface of the chamber 2a. The EUV light sensors 70c to 70e correspond to a second sensor in the present disclosure.

The EUV light sensors 70c to 70e are directed to the plasma generation region 25. The EUV light sensors 70c and 70d are arranged in a mirror image relationship with a virtual plane parallel to an XZ plane and passing through the plasma generation region 25 therebetween. The EUV light sensors 70d and 70e are arranged in a mirror image relationship with a virtual plane parallel to a YZ plane and passing through the plasma generation region 25 therebetween.

The EUV light sensor 70c includes an energy measuring unit 71c, an EUV light transmission filter 72c, and a casing 73c. The energy measuring unit 71c and the EUV light transmission filter 72c are housed in the casing 73c. An interior of the casing 73c communicates with an interior of the chamber 2a through an opening 21c in the chamber 2a. Components of the EUV light sensors 70d, 70e are similar to those of the EUV light sensor 70c. The components of the EUV light sensor 70d are denoted by reference numerals with “d” at the end, and the components of the EUV light sensor 70e are denoted by reference numerals with “e” at the end.

2.2 Operation

2.2.1 Output of Target

The EUV light generation control unit 5 outputs a control signal to the target supply unit 26. A target substance held in the target supply unit 26 is maintained at a temperature equal to or higher than a melting point of the target substance by a heater (not shown). The target substance in the target supply unit 26 is pressurized by an inert gas supplied into the target supply unit 26.

The target substance pressurized by the inert gas is output as a jet through the opening. The vibrating device vibrates at least components of the target supply unit 26 around the opening, thereby separating the jet of the target substance into a plurality of droplets. The droplets constitute the target 27. The target 27 moves in a −Y direction from the target supply unit 26 toward the plasma generation region 25.

The target recovery unit 28 recovers the target 27 having passed through the plasma generation region 25.

2.2.2 Output of Pulse Laser Beam

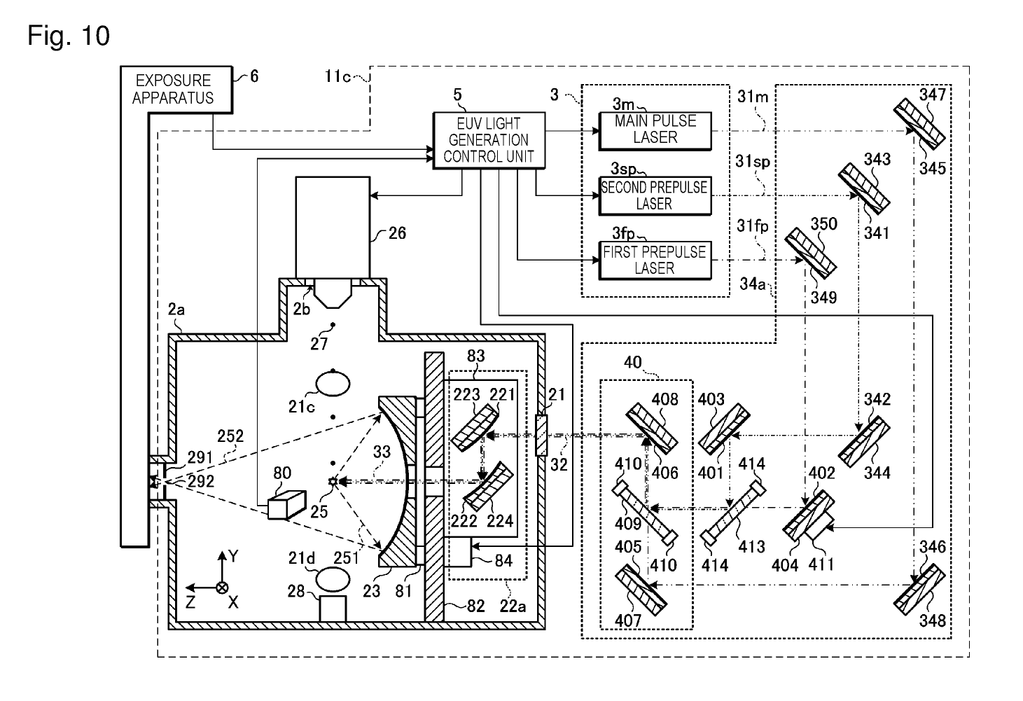

The EUV light generation control unit 5 outputs a first trigger signal to the first prepulse laser 3fp. The first prepulse laser 3fp outputs the first prepulse laser beam 31fp according to the first trigger signal. The EUV light generation control unit 5 outputs the first trigger signal and then outputs a third trigger signal to the main pulse laser 3m. A second trigger signal will be described later with reference to FIG. 10. The main pulse laser 3m outputs the main pulse laser beam 31m according to the third trigger signal. As such, the laser apparatus 3 outputs the first prepulse laser beam 31fp and the main pulse laser beam 31m in this order. The first prepulse laser beam 31fp preferably has a pulse time width of picosecond-order. The picosecond-order refers to 1 ps or more and less than 1 ns.

2.2.3 Transmission of Pulse Laser Beam

The first prepulse laser beam 31fp and the main pulse laser beam 31m enter the laser beam traveling direction control unit 34a.

In the laser beam traveling direction control unit 34a, a sensor (not shown) detects the first prepulse laser beam 31fp and the main pulse laser beam 31m and outputs a detection result to the EUV light generation control unit 5. The EUV light generation control unit 5 calculates beam positions and beam pointings of the first prepulse laser beam 31fp and the main pulse laser beam 31m based on the output of the sensor. The EUV light generation control unit 5 controls the actuators (not shown) of the holders 350, 404, 347, 348 based on the beam positions and the beam pointings.

2.2.4 Focusing of Pulse Laser Beam

The first prepulse laser beam 31fp and the main pulse laser beam 31m are guided through the laser beam traveling direction control unit 34a into the laser beam focusing optical system 22a as the pulse laser beam 32. The pulse laser beam 32 is reflected by the off-axis parabolic convex mirror 221 included in the laser beam focusing optical system 22a and thus expanded. The pulse laser beam 32 reflected by the off-axis parabolic convex mirror 221 is reflected by the ellipsoidal concave mirror 222 and focused on the plasma generation region 25 as a pulse laser beam 33. The pulse laser beam 33 includes the first prepulse laser beam 31fp and the main pulse laser beam 31m.

The laser beam focusing optical system actuator 84 adjusts a position of the plate 83 relative to the plate 82. The laser beam focusing optical system actuator 84 is controlled by a control signal output from the EUV light generation control unit 5. The position of the plate 83 is adjusted to adjust positions of the off-axis parabolic convex mirror 221 and the ellipsoidal concave mirror 222. Moving the off-axis parabolic convex mirror 221 and the ellipsoidal concave mirror 222 varies the optical path axes of the first prepulse laser beam 31fp and the main pulse laser beam 31m included in the pulse laser beam 33. As described above, the second focal point of the ellipsoidal concave mirror 222 substantially matches a focusing point of the pulse laser beam 33. Thus, a moving direction and a moving distance of the plate 83 by the laser beam focusing optical system actuator 84 substantially match a moving direction and a moving distance of the focusing point of the pulse laser beam 33, respectively.

At timing when one target 27 reaches the plasma generation region 25, the target 27 is irradiated with the first prepulse laser beam 31fp. The target 27 irradiated with the first prepulse laser beam 31fp is expanded or diffused into a secondary target. The secondary target contains mist of the target substance. At timing when the secondary target is expanded or diffused into a desired size, the secondary target is irradiated with the main pulse laser beam 31m. The secondary target irradiated with the main pulse laser beam 31m is turned into plasma, and radiation light 251 including EUV light is radiated from the plasma.

2.2.5 Detection of EUV Gravity Center Position

The EUV light sensors 70c to 70e detect energy of the EUV light radiated from the plasma and reaching the EUV light sensors 70c to 70e. The EUV light generation control unit 5 calculates an EUV gravity center position based on the energy of the EUV light detected by the EUV light sensors 70c to 70e as described below.

Since the EUV light radiated from the plasma has spatial emission distribution, the energy of the EUV light detected by the EUV light sensors 70c to 70e differs depending on its radiation direction. For example, with energies of the EUV light detected by the EUV light sensors 70c and 70d being E1 and E2, if the energy E2 is larger than the energy E1, the radiation direction of the EUV light can be assumed to be deviated closer to the EUV light sensor 70d than the EUV light sensor 70c.

Thus, an EUV gravity center position in the Y direction is calculated based on a difference between the energies E1 and E2 of the EUV light detected by the EUV light sensors 70c and 70d. Also, an EUV gravity center position in the X direction is calculated based on a difference between the energies E2 and E3 of the EUV light detected by the EUV light sensors 70d and 70e. For example, the EUV gravity center position in the Y direction is calculated by an expression (E1−E2)/(E1+E2). The EUV gravity center position in the X direction is calculated by an expression (E2−E3)/(E2+E3).

The EUV gravity center position varies depending on a focusing position of the pulse laser beam 33. The focusing position of the pulse laser beam 33 can be estimated based on the EUV gravity center position. The EUV light generation control unit 5 can control the laser beam focusing optical system actuator 84 based on the EUV gravity center position to adjust the focusing position of the pulse laser beam 33.

2.3 Problem

The outputs of the EUV light sensors 70c to 70e are sometimes sensitive to disturbances of the trajectory of the target 27, the focusing position of the pulse laser beam 33, pulse energy of the pulse laser beam 33, or the like. If such disturbances simultaneously occur, the outputs of the EUV light sensors 70c to 70e may show unexpected outliers. Controlling the focusing position of the pulse laser beam 33 with the unexpected outliers may cause the focusing point of the pulse laser beam 33 to move to a region with a nonlinear correlation between the focusing position of the pulse laser beam 33 and the EUV gravity center position. In such a case, the control of the focusing position of the pulse laser beam 33 based on the outputs of the EUV light sensors 70c to 70e may fail, thereby preventing the focusing position of the pulse laser beam 33 from returning to a proper position. This may reduce quality of the EUV light.

In an embodiment described below, a predetermined parameter on a target is calculated based on an image of the target after irradiation with a first prepulse laser beam 31fp and before irradiation with a main pulse laser beam 31m. If the parameter does not satisfy a first condition, control of a focusing position of a pulse laser beam 33 based on an EUV gravity center position is stopped, and control of the focusing position of the pulse laser beam 33 based on a reference position is performed. Thus, the focusing position of the pulse laser beam 33 is returned to a region where the control based on the EUV gravity center position can be performed, thereby allowing the control based on the EUV gravity center position to be then restarted.

### 3. EUV Light Generation System Including Mist Sensor 80

3.1 Configuration

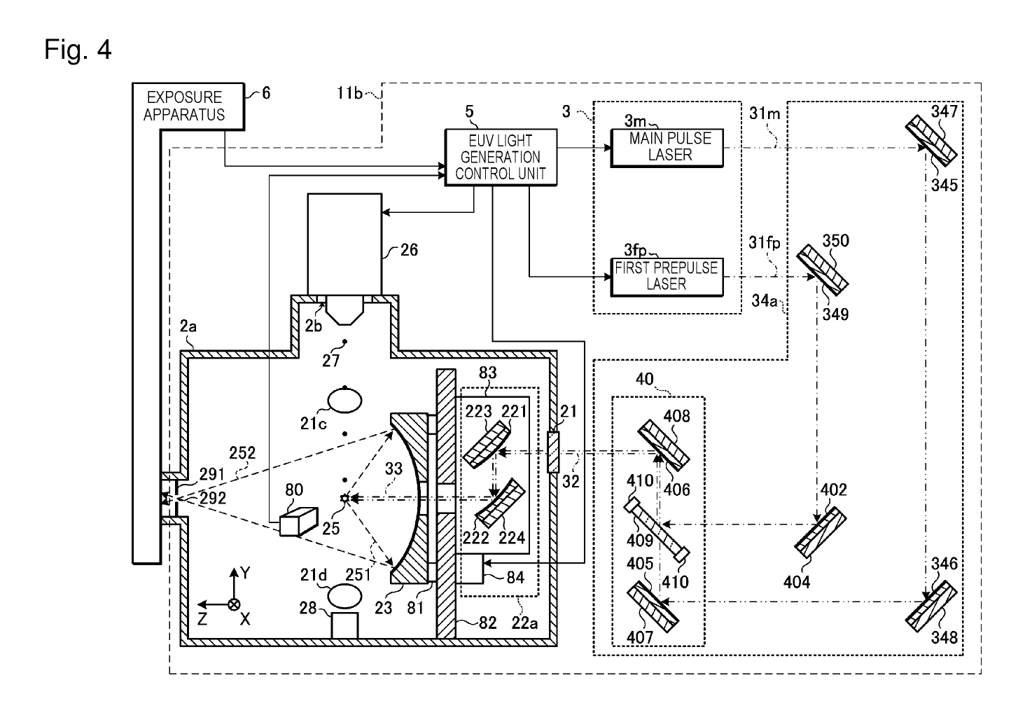

FIG. 4 is a partial sectional view of a configuration of an EUV light generation system 11b according to a first embodiment of the present disclosure. In the first embodiment, the EUV light generation system 11b includes a mist sensor 80 in addition to the configuration of the comparative example. The mist sensor 80 corresponds to a first sensor in the present disclosure.

The mist sensor 80 is arranged in a predetermined position away from a plasma generation region 25 substantially in a −X direction. For example, the mist sensor 80 is located outside a chamber 2a. A window (not shown) is located in a wall surface of the chamber 2a between the plasma generation region 25 and the mist sensor 80. The position of the mist sensor 80 is not limited to the position away from the plasma generation region 25 in the −X direction. The mist sensor 80 may be arranged in a direction such that a Y direction can be specified on an image captured by the mist sensor 80.

The mist sensor 80 includes, for example, a transfer optical system and an image sensor. The transfer optical system is arranged so that an image of a secondary target formed by irradiating a target with the first prepulse laser beam 31fp in the plasma generation region 25 is formed on a light receiving surface of the image sensor. The mist sensor 80 outputs image data of the secondary target captured by the image sensor to an EUV light generation control unit 5.

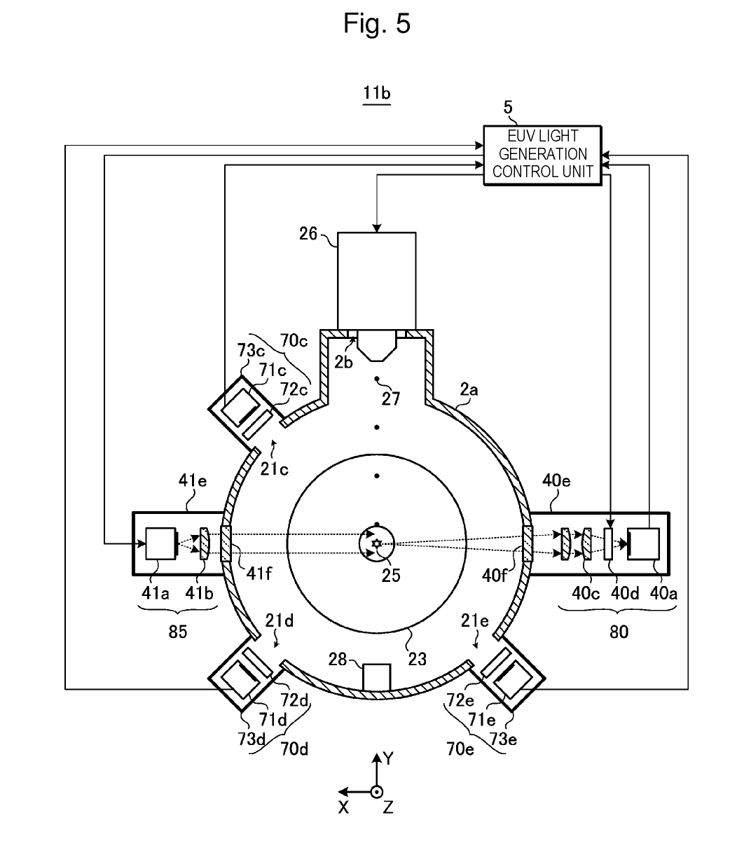

FIG. 5 is a partial sectional view of an exemplary configuration of the mist sensor 80. The mist sensor 80 is used together with a light source unit 85.

The mist sensor 80 and the light source unit 85 are arranged on substantially opposite sides of the plasma generation region 25.

The mist sensor 80 includes an image sensor 40a, a transfer optical system 40c, an optical shutter 40d, and a casing 40e. The image sensor 40a is constituted by, for example, a CCD sensor. The image sensor 40a, the transfer optical system 40c, and the optical shutter 40d are housed in the casing 40e. A window 40f is arranged in the wall surface of the chamber 2a between the casing 40e and the chamber 2a.

The light source unit 85 includes a flash lamp 41a, an illumination optical system 41b, and a casing 41e. The flash lamp 41a and the illumination optical system 41b are housed in the casing 41e. A window 41f is arranged in the wall surface of the chamber 2a between the casing 41e and the chamber 2a.

3.2 Operation

In the light source unit 85, the flash lamp 41a emits visible light based on a control signal from the EUV light generation control unit 5. The light emitted from the flash lamp 41a passes through the illumination optical system 41b and reaches the plasma generation region 25.

In the mist sensor 80, the transfer optical system 40c forms an image of an object existing in the plasma generation region 25 on a light receiving surface of the image sensor 40a. The image sensor 40a outputs image data indicating light intensity distribution of the image formed on the light receiving surface to the EUV light generation control unit 5. The optical shutter 40d is opened/closed based on a control signal from the EUV light generation control unit 5.

The mist sensor 80 can capture an image of a secondary target after a target 27 having reached the plasma generation region 25 is irradiated with the first prepulse laser beam 31fp and before irradiated with the main pulse laser beam 31m. At this time, an opening time of the optical shutter 40d is set to, for example, a nanosecond-order. The EUV light generation control unit 5 calculates a predetermined parameter on the target based on the image data obtained from the mist sensor 80.

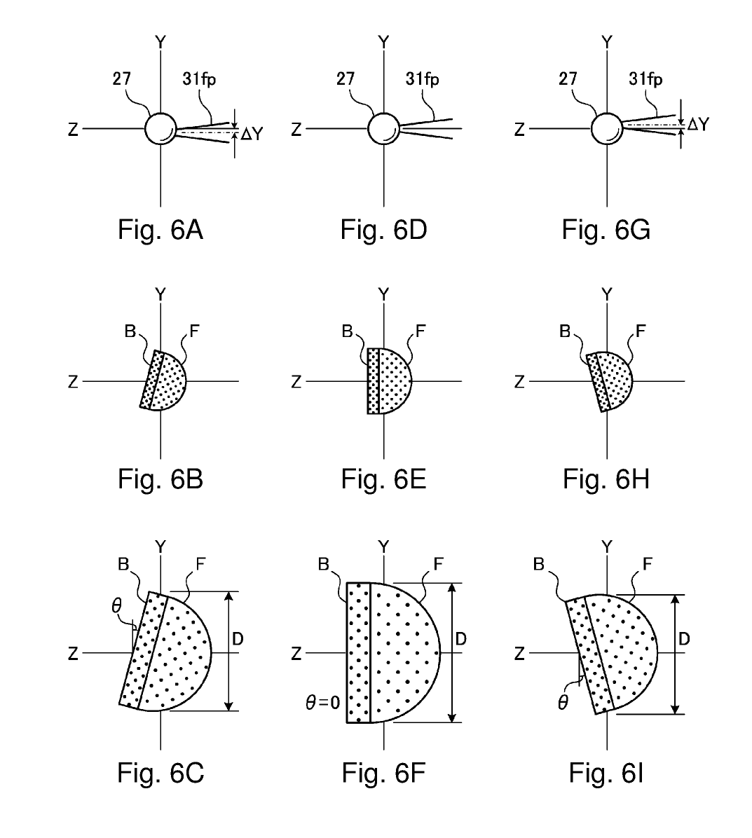

FIGS. 6A to 6I illustrate a principle of estimating a deviation of a focusing position of the first prepulse laser beam 31fp based on an image of the target immediately after irradiation with the first prepulse laser beam 31fp. FIGS. 6A to 6C show images captured by the image sensor 40a when the first prepulse laser beam 31fp is applied to the spherical target 27 in a deviated manner in a −Y direction from a center of the target 27. FIGS. 6D to 6F show images captured by the image sensor 40a when the first prepulse laser beam 31fp is applied to substantially the center of the spherical target 27. FIGS. 6G to 6I show images captured by the image sensor 40a when the first prepulse laser beam 31fp is applied to the spherical target 27 in a deviated manner in a +Y direction from the center of the target 27. FIGS. 6A, 6D, and 6G show images of the target 27 irradiated with the first prepulse laser beam 31fp. FIGS. 6B, 6E, and 6H show images of the secondary target diffused into a domical shape by application of the first prepulse laser beam 31fp. FIGS. 6C, 6F, and 6I show enlarged images of the secondary target in FIGS. 6B, 6E, and 6H, respectively.

When the first prepulse laser beam 31fp is applied to the target 27 in the Z direction from a −Z side, sudden laser ablation occurs on a surface of the target 27 on the −Z side, and the target may be broken into pieces and diffused into the domical shape. An outline of the image of the target diffused into the domical shape may include a curved part F on the −Z side and a substantially linear part B on a +Z side.

As shown in FIGS. 6D to 6F, if the first prepulse laser beam 31fp is applied to substantially the center of the target 27, a size of the secondary target, for example, a diameter of the secondary target in the Y direction is large.

As shown in FIGS. 6A to 6C, if the first prepulse laser beam 31fp is applied to the target 27 in the deviated manner in the −Y direction from the center of the target 27, the size of the secondary target, for example, the diameter of the secondary target in the Y direction is relatively small.

As shown in FIGS. 6G to 6I, if the first prepulse laser beam 31fp is applied to the target 27 in the deviated manner in the +Y direction from the center of the target 27, the size of the secondary target, for example, the diameter of the secondary target in the Y direction is relatively small.

The size of the secondary target or the diameter of the secondary target in the Y direction is an example of a predetermined parameter in the present disclosure. In the following description, the diameter of the secondary target in the Y direction is referred to as a mist diameter D.

The mist diameter D varies depending on an elapsed time since the first prepulse laser beam 31fp is applied to the target 27. Thus, when the mist diameter D is obtained as a predetermined parameter, the optical shutter 40d is opened/closed within a set time since the first prepulse laser beam 31fp is applied to the target 27. For example, the optical shutter 40d is opened/closed within a set time of 400 ns to 1000 ns since the first prepulse laser beam 31fp is applied to the target 27. The mist diameter D is, for example, in the range of about 200 μm to 400 μm.

As shown in FIGS. 6D to 6F, if the first prepulse laser beam 31fp is applied to substantially the center of the target 27, an outline of the secondary target diffused into the domical shape is substantially symmetrical with respect to a Z axis, and the substantially linear part B is substantially parallel to a Y axis.

As shown in FIGS. 6A to 6C, if the first prepulse laser beam 31fp is applied to the target 27 in the deviated manner in the −Y direction from the center of the target 27, the substantially linear part B is slightly inclined clockwise with respect to the Y axis.

As shown in FIGS. 6G to 6I, if the first prepulse laser beam 31fp is applied to the target 27 in the deviated manner in the +Y direction from the center of the target 27, the substantially linear part B is slightly inclined counterclockwise with respect to the Y axis.

The inclination of the secondary target, for example, an inclination angle of the secondary target with respect to the Y axis is an example of a predetermined parameter in the present disclosure. In the following description, the inclination angle of the secondary target with respect to the Y axis is referred to as a mist angle θ.

The EUV light generation control unit 5 calculates a predetermined parameter based on the image data of the secondary target captured by the image sensor 40a. This allows the EUV light generation control unit 5 to detect a deviation of the focusing position of the first prepulse laser beam 31fp.

3.2.1 Main Flow

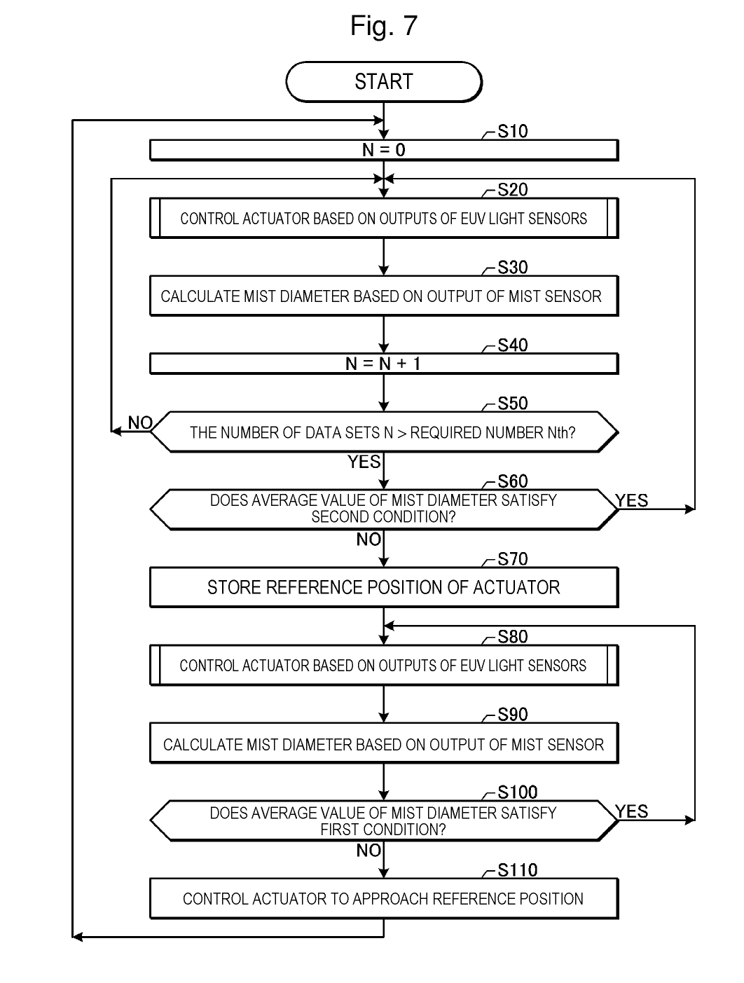

FIG. 7 is a flowchart of a procedure of an optical path axis adjustment in the first embodiment. The EUV light generation control unit 5 adjusts the focusing position of the pulse laser beam by the following processing.

First, in S10, the EUV light generation control unit 5 sets a value of a counter N to 0. The counter N is used to count the number of data sets for calculating an average value of the mist diameter D. The average value of the mist diameter D is calculated, for example, every time one target 27 is irradiated with the first prepulse laser beam 31fp. In this case, the value of the counter N is counted up every time one target 27 is irradiated with the first prepulse laser beam 31fp.

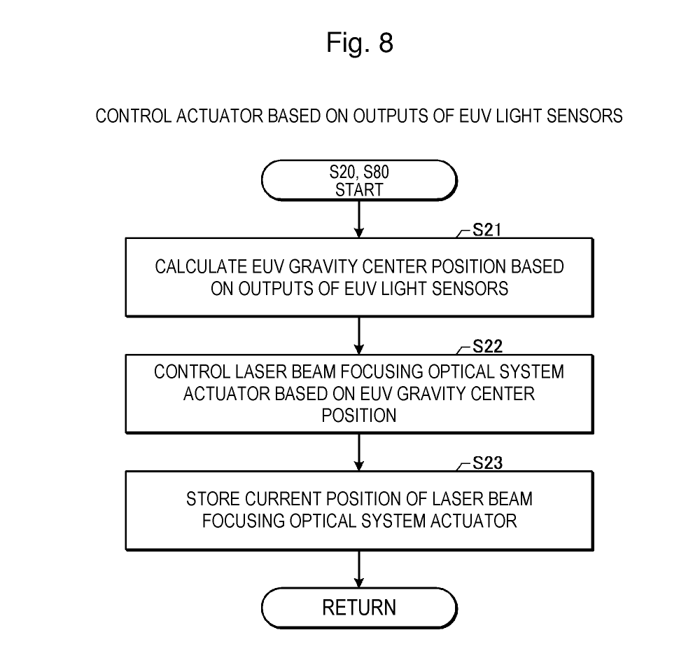

Next, in S20, the EUV light generation control unit 5 controls an actuator based on outputs of EUV light sensors 70c to 70e. In the first embodiment, a laser beam focusing optical system actuator 84 is controlled as the actuator. Details of the process in S20 will be described later with reference to FIG. 8.

Next, in S30, the EUV light generation control unit 5 calculates the mist diameter D of the secondary target based on the image data output from the mist sensor 80.

Next, in S40, the EUV light generation control unit 5 adds one to the value of the counter N to update the value of the counter N.

Next, in S50, the EUV light generation control unit 5 determines whether or not the value of the counter N indicating the number of data sets is larger than a required number Nth. The required number Nth may be an integer, for example, in the range of 10 to 100. If the value of the counter N is larger than the required number Nth (S50: YES), the EUV light generation control unit 5 goes to a process in S60. If the value of the counter N is not larger than the required number Nth (S50: NO), the EUV light generation control unit 5 returns to the process in S20 and repeats the processes in S20 to S50.

In S60, the EUV light generation control unit 5 calculates an average value of the mist diameter D using the latest Nth data sets, and determines whether or not the average value satisfies a second condition. The average value of the mist diameter D is calculated, for example, as a moving average of the mist diameter D included in the latest Nth data sets.

For example, it is determined that the average value of the mist diameter D satisfies the second condition if the average value is equal to or larger than an allowable value T. It is determined that the average value of the mist diameter D does not satisfy the second condition if the average value is smaller than the allowable value T. The allowable value T of the mist diameter D is given by, for example, T=k×0.9, where k is a mist diameter D under an ideal irradiation condition. The allowable value T of the mist diameter D corresponds to a second predetermined value in the present disclosure.

If the average value of the mist diameter D satisfies the second condition (S60: YES), the EUV light generation control unit 5 returns to the process in S20 and repeats the processes in S20 to S60.

If the average value of the mist diameter D does not satisfy the second condition (S60: NO), the EUV light generation control unit 5 goes to a process in S70.

In S70, the EUV light generation control unit 5 calculates a reference position of the actuator and stores the calculated reference position. As the reference position of the actuator, a position of the actuator immediately before the average value of the mist diameter D does not satisfy the second condition is used. Alternatively, as the reference position of the actuator, an average value of the position of the actuator calculated from a plurality of data sets immediately before the average value of the mist diameter D does not satisfy the second condition is used.

The position of the actuator does not necessarily refer to a position where the actuator exists. For example, if the actuator is a piezoelectric actuator and is expanded/contracted to vary a position of a second point relative to a first point, the position of the actuator refers to the position of the second point relative to the first point.

Next, in S80, the EUV light generation control unit 5 controls the actuator based on the outputs of the EUV light sensors 70c to 70e. A process in S80 is similar to that in S20. Details of the process in S20 will be described later with reference to FIG. 8.

Next, in S90, the EUV light generation control unit 5 calculates a mist diameter D of the secondary target based on the image data output from the mist sensor 80. A process in S90 is similar to that in S30.

Next, in S100, the EUV light generation control unit 5 calculates an average value of the mist diameter D using the latest Nth data sets, and determines whether or not the average value satisfies a first condition. The average value of the mist diameter D is calculated, for example, as a moving average of the mist diameter D included in the latest Nth data sets.

For example, it is determined that the average value of the mist diameter D satisfies the first condition if the average value is larger than an abnormal value Er. It is determined that the average value of the mist diameter D does not satisfy the first condition if the average value is equal to or smaller than the abnormal value Er. The abnormal value Er of the mist diameter D is given by, for example, T=k×0.8, where k is a mist diameter D under an ideal irradiation condition. Specifically, the abnormal value Er of the mist diameter D is smaller than the allowable value T. The abnormal value Er of the mist diameter D corresponds to a first predetermined value in the present disclosure.

If the average value of the mist diameter D satisfies the first condition (S100: YES), the EUV light generation control unit 5 returns to the process in S80 and repeats the processes in S80 to S100. In S80, the EUV light generation control unit 5 controls the actuator based on the outputs of the EUV light sensors 70c to 70e.

If the average value of the mist diameter D does not satisfy the first condition (S100: NO), the EUV light generation control unit 5 goes to a process in S110.

In S110, the EUV light generation control unit 5 controls the actuator in order for the actuator to approach the reference position. This reference position is the one stored in S70. Thus, if the average value of the mist diameter D reaches the abnormal value, control based on the reference position is performed instead of the control based on the outputs of the EUV light sensors 70c to 70e.

After S110, the EUV light generation control unit 5 returns to the process in S10. Then, in S20, the EUV light generation control unit 5 returns to the control based on the outputs of the EUV light sensors 70c to 70e.

3.2.2 Control of Actuator Based on Outputs of EUV Light Sensors

FIG. 8 is a flowchart of detailed processing of controlling the actuator based on the outputs of the EUV light sensors 70c to 70e in the first embodiment. The processing in FIG. 8 is performed by the EUV light generation control unit 5 as a subroutine of S20 or S80 in FIG. 7.

First, in S21, the EUV light generation control unit 5 calculates an EUV gravity center position based on the outputs of EUV light sensors 70c to 70e.

Next, in S22, the EUV light generation control unit 5 controls the actuator based on the EUV gravity center position. In the first embodiment, the EUV light generation control unit 5 controls the laser beam focusing optical system actuator 84 to control focusing positions of both the first prepulse laser beam 31fp and the main pulse laser beam 31m. In the control of the actuator in S22, the EUV gravity center position calculated in S21 may be used as it is, or an average value calculated based on a data set of a plurality of EUV gravity center positions obtained by performing the process in S21 a plurality of times may be used. The average value of the EUV gravity center position may be a moving average. The number of samples for calculating the average value may be an integer in the range of 100 to 10000.

Next, in S23, the EUV light generation control unit 5 stores a current position of the actuator. In the first embodiment, a current position of the laser beam focusing optical system actuator 84 is stored. The position of the actuator stored in S23 is used for calculating the reference position of the laser beam focusing optical system actuator 84 in S70. In S110, the laser beam focusing optical system actuator 84 is controlled to approach the reference position.

After S23, the EUV light generation control unit 5 finishes the processing in this flowchart and returns to the processing in FIG. 7.

3.3 Effect

According to the first embodiment, when the average value of the mist diameter D satisfies the first condition or the second condition (S100: YES, S60: YES), the laser beam focusing optical system actuator 84 is controlled based on the outputs of the EUV light sensors 70c to 70e (S80, S20). This allows the focusing position of the pulse laser beam 33 to be aligned with the target 27 with high accuracy.

Also, according to the first embodiment, a sign of failure in the control based on the outputs of the EUV light sensors 70c to 70e is detected using the mist diameter D or the average value thereof as an indicator. If the mist diameter D or the average value thereof does not satisfy the first condition (S100: NO), the control based on the outputs of EUV light sensors 70c to 70e is stopped, and the laser beam focusing optical system actuator 84 is controlled based on the reference position of the laser beam focusing optical system actuator 84 (S110). The laser beam focusing optical system actuator 84 is brought close to the reference position, and then the EUV light generation control unit 5 can return to the control of the actuator based on the outputs of the EUV light sensors 70c to 70e.

Also, according to the first embodiment, the reference position of the laser beam focusing optical system actuator 84 is calculated based on the data set when the average value of the mist diameter D satisfies the second condition. The second condition is closer to an ideal condition than the first condition. This allows the position of the laser beam focusing optical system actuator 84 to be brought close to an ideal position.

### 4. EUV Light Generation System Configured to Determine First and Second Conditions Based on Inclination of Secondary Target

4.1 Main Flow

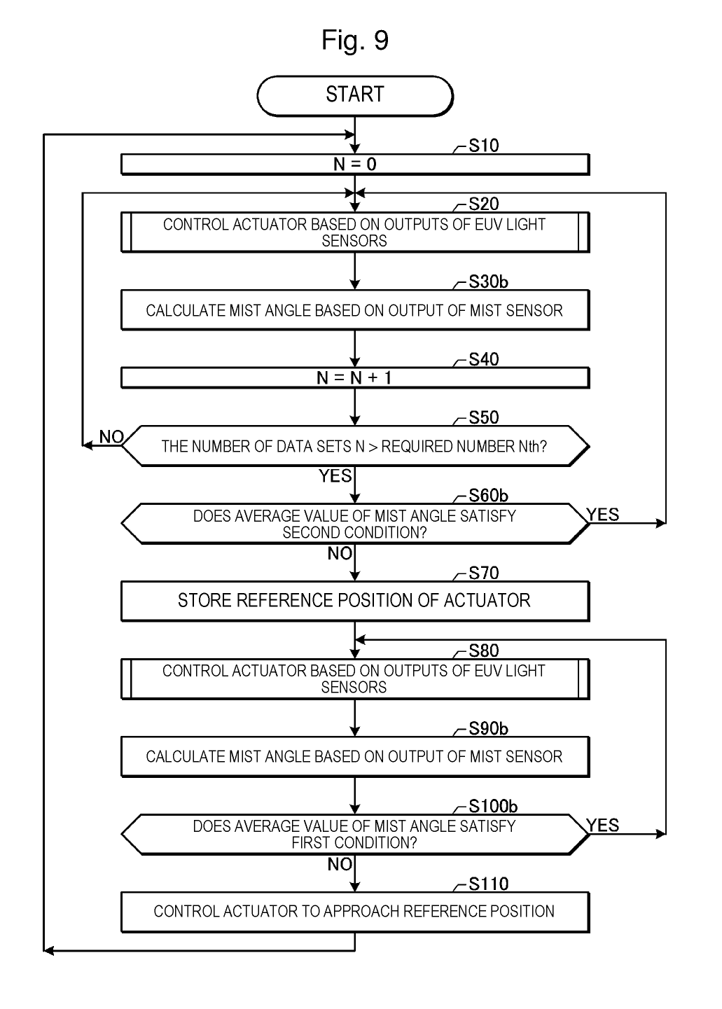

FIG. 9 is a flowchart of a procedure of an optical path axis adjustment in a second embodiment of the present disclosure. A configuration of an EUV light generation system according to the second embodiment is similar to that described with reference to FIGS. 4 and 5.

In the second embodiment, an EUV light generation control unit 5 determines first and second conditions based on an inclination of a secondary target, for example, a mist angle θ. In this respect, the second embodiment is different from the first embodiment in which the EUV light generation control unit 5 determines the first and second conditions based on the size of the secondary target, for example, the mist diameter D.

Specifically, in S30b and S90b in FIG. 9, the EUV light generation control unit 5 calculates a mist angle θ based on image data output from a mist sensor 80.

In S60b in FIG. 9, the EUV light generation control unit 5 determines whether or not an average value of the mist angle θ satisfies the second condition.

For example, it is determined that the average value of the mist angle θ satisfies the second condition if the average value is equal to or smaller than an allowable value T. It is determined that the average value of the mist angle θ does not satisfy the second condition when the average value is larger than the allowable value T. The allowable value T of the mist angle θ is, for example, in the range of 0.5 deg to 5 deg. The allowable value T of the mist angle θ corresponds to a fourth predetermined value in the present disclosure.

As a reference position stored in S70 in FIG. 9, a position of an actuator immediately before the average value of the mist angle θ does not satisfy the second condition is used. Alternatively, as the reference position of the actuator, an average value of a position of the actuator calculated from a plurality of data sets immediately before the average value of the mist angle θ does not satisfy the second condition is used.

In S100b in FIG. 9, the EUV light generation control unit 5 determines whether or not the average value of the mist angle θ satisfies the first condition.

For example, it is determined that the average value of the mist angle θ satisfies the first condition if the average value is smaller than an abnormal value Er. It is determined that the average value of the mist angle θ does not satisfy the first condition if the average value is equal to or larger than the abnormal value Er. The abnormal value Er of the mist angle θ is, for example, in the range of 2.5 deg to 10 deg and larger than the allowable value T. The abnormal value Er of the mist angle θ corresponds to a third predetermined value in the present disclosure.

Other points are similar to those in the first embodiment.

4.2 Effect

According to the second embodiment, a sign of failure in control based on outputs of EUV light sensors 70c to 70e is detected using the mist angle θ or the average value thereof as an indicator. The mist angle θ may have a smaller error due to time after application of the first prepulse laser beam 31fp than the mist diameter D. This may allow the sign of failure in the control based on the outputs of the EUV light sensors 70c to 70e to be precisely detected.

### 5. EUV Light Generation System Configured to Control Mirror Actuator 411

5.1 Configuration

FIG. 10 is a partial sectional view of a configuration of an EUV light generation system 11c according to a third embodiment of the present disclosure. In the third embodiment, a laser beam traveling direction control unit 34a includes a mirror actuator 411.

Further, in the third embodiment, a laser apparatus 3 includes a second prepulse laser 3sp. Also, in the third embodiment, the laser beam traveling direction control unit 34a includes high reflection mirrors 341, 342, 401 and a beam combiner 413.

Other than the above, a configuration of the EUV light generation system 11c according to the third embodiment is similar to that of the EUV light generation system 11b according to the first embodiment.

The mirror actuator 411 is mounted to a holder 404 of a high reflection mirror 402. The mirror actuator 411 is configured to change an orientation of the high reflection mirror 402 to change a reflection direction of a first prepulse laser beam 31fp. Changing the reflection direction of the first prepulse laser beam 31fp by the high reflection mirror 402 can vary an optical path axis of the first prepulse laser beam 31fp and change a focusing position of the first prepulse laser beam 31fp.

A second prepulse laser 3sp is configured to output a second prepulse laser beam 31sp. The second prepulse laser 3sp is constituted by, for example, a YAG laser apparatus or a laser apparatus using Nd:YVO₄. The second prepulse laser 3sp includes a laser oscillator and, as required, a laser amplifier.

The high reflection mirrors 341, 342 are arranged in an optical path of the second prepulse laser beam 31sp. The high reflection mirror 341 is supported by a holder 343. The high reflection mirror 342 is supported by a holder 344. An actuator (not shown) may be mounted to each of the holders 343, 344.

The high reflection mirror 401 is arranged in an optical path of the second prepulse laser beam 31sp reflected by the high reflection mirror 342. The high reflection mirror 401 is supported by a holder 403.

The beam combiner 413 is located in an optical path of the first prepulse laser beam 31fp reflected by the high reflection mirror 402. The beam combiner 413 is also located in an optical path of the second prepulse laser beam 31sp reflected by the high reflection mirror 401. The beam combiner 413 is supported by a holder 414. The beam combiner 413 is constituted by, for example, a polarizing beam splitter. The beam combiner 413 is configured to reflect the second prepulse laser beam 31sp with high reflectance and transmit the first prepulse laser beam 31fp with high transmittance. The beam combiner 413 is configured to direct the first prepulse laser beam 31fp and the second prepulse laser beam 31sp to the beam combiner 409 with their optical path axes substantially matched.

5.2 Operation

An EUV light generation control unit 5 outputs the first trigger signal as described above, and then outputs a second trigger signal to the second prepulse laser 3sp. The second prepulse laser 3sp outputs the second prepulse laser beam 31sp according to the second trigger signal. The EUV light generation control unit 5 outputs the second trigger signal, and then outputs a third trigger signal to a main pulse laser 3m. The laser apparatus 3 outputs the first prepulse laser beam 31fp, the second prepulse laser beam 31sp, and a main pulse laser beam 31m in this order.

The first prepulse laser beam 31fp, the second prepulse laser beam 31sp, and the main pulse laser beam 31m enter the laser beam traveling direction control unit 34a.

In the laser beam traveling direction control unit 34a, a sensor (not shown) detects the second prepulse laser beam 31sp. The EUV light generation control unit 5 calculates a beam position and a beam pointing of the second prepulse laser beam 31sp based on an output of the sensor. The EUV light generation control unit 5 controls the actuators (not shown) on the holders 343, 344 based on the beam position and the beam pointing. This is similar to that as described on the first prepulse laser beam 31fp and the main pulse laser beam 31m.

In the laser beam traveling direction control unit 34a, the second prepulse laser beam 31sp reflected by the beam combiner 413 passes through an optical path similar to that described on the first prepulse laser beam 31fp with reference to FIG. 2 and is focused on a plasma generation region 25 as part of a pulse laser beam 33.

5.2.1 Control of Actuator Based on Outputs of EUV Light Sensors

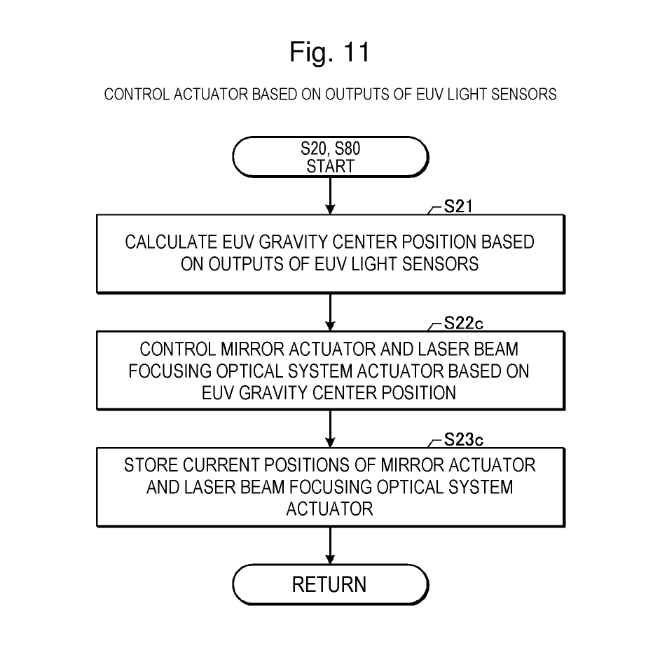

FIG. 11 is a flowchart of detailed processing of controlling the actuator based on outputs of EUV light sensors 70c to 70e in the third embodiment. A main flow in the third embodiment is similar to that described with reference to FIG. 7 or 9. Specifically, the main flow in the third embodiment may be directed to detect a mist diameter D as in the first embodiment or detect a mist angle θ as in the second embodiment.

The processing in FIG. 11 is performed by the EUV light generation control unit 5 as a subroutine of S20 or S80 in FIG. 7 or 9.

First, in S21, the EUV light generation control unit 5 calculates an EUV gravity center position based on the outputs of the EUV light sensors 70c to 70e. This is similar to that as described with reference to FIG. 8.

Next, in S22c, the EUV light generation control unit 5 controls the actuator based on the EUV gravity center position. In the third embodiment, the EUV light generation control unit 5 controls the mirror actuator 411 to change the reflection direction of the first prepulse laser beam 31fp by the high reflection mirror 402 to control a focusing position of the first prepulse laser beam 31fp. The EUV light generation control unit 5 can further control the laser beam focusing optical system actuator 84 to simultaneously control three focusing positions of the first prepulse laser beam 31fp, the second prepulse laser beam 31sp, and the main pulse laser beam 31m. For example, the mirror actuator 411 may be controlled based on the EUV gravity center position at short intervals, and the laser beam focusing optical system actuator 84 may be controlled based on a control amount of the mirror actuator 411 at long intervals.

Next, in S23c, the EUV light generation control unit 5 stores a current position of the actuator. In the third embodiment, current positions of the mirror actuator 411 and the laser beam focusing optical system actuator 84 are stored. The positions of the actuators stored in S23c are used for calculating reference positions of the mirror actuator 411 and the laser beam focusing optical system actuator 84 in S70 in FIG. 7 or 9. In S110, the mirror actuator 411 and the laser beam focusing optical system actuator 84 are controlled to approach the respective reference positions.

After S23c, the EUV light generation control unit 5 finishes the processing in this flowchart and returns to the processing in FIG. 7 or 9.

5.3 Effect

According to the third embodiment, the mirror actuator 411 is controlled based on the EUV gravity center position to control the focusing position of the first prepulse laser beam 31fp. The high reflection mirror 402 driven by the mirror actuator 411 can be lighter in weight than the laser beam focusing optical system 22a and can be driven at high speed.

Also, the second prepulse laser beam 31sp and the main pulse laser beam 31m are applied to a diffused target, while the first prepulse laser beam 31fp is applied to a minute drop-like target 27. Thus, the control of the focusing position of the first prepulse laser beam 31fp may have an effect on stability of the EUV light.

According to the third embodiment, the focusing position of the first prepulse laser beam 31fp can be controlled at high response speed.

### 6. Supplementation

The above descriptions are intended to be illustrative only and not restrictive. Thus, it will be apparent to those skilled in the art that modifications may be made in the embodiments of the present disclosure without departing from the scope of the appended claims.

The terms used throughout the specification and the appended claims should be interpreted as “non-limiting.” For example, the term “comprising” or “comprised” should be interpreted as “not limited to what has been described as being comprised.” The term “having” should be interpreted as “not limited to what has been described as having.” Further, the modifier “a/an” described in the specification and the appended claims should be interpreted to mean “at least one” or “one or more.”

What is claimed is:

1. An extreme ultraviolet light generation system comprising:
a target supply unit configured to output a target toward a predetermined region;
a prepulse laser configured to output a prepulse laser beam to be applied to the target in the predetermined region;
a main pulse laser configured to output a main pulse laser beam to be applied to the target irradiated with the prepulse laser beam in the predetermined region;
a light focusing optical system configured to focus the prepulse laser beam and the main pulse laser beam on the predetermined region;
an actuator configured to change a focusing position of the prepulse laser beam by the light focusing optical system;
a first sensor configured to capture an image of the target after irradiation with the prepulse laser beam and before irradiation with the main pulse laser beam; and
a control unit configured to store a reference position of the actuator, calculate a predetermined parameter on the target after irradiation with the prepulse laser beam and before irradiation with the main pulse laser beam based on image data obtained from the first sensor, and control the actuator to approach the reference position if the predetermined parameter does not satisfy a first condition.

2. The extreme ultraviolet light generation system according to claim 1, further comprising a second sensor configured to detect light radiated from the predetermined region after the target is irradiated with the main pulse laser beam,
wherein the control unit controls the actuator based on data obtained from the second sensor if the predetermined parameter satisfies the first condition.

3. The extreme ultraviolet light generation system according to claim 2, wherein the second sensor detects extreme ultraviolet light radiated from the predetermined region, and
the control unit calculates a gravity center position of a source of the extreme ultraviolet light based on the data obtained from the second sensor and controls the actuator based on the gravity center position.

4. The extreme ultraviolet light generation system according to claim 1, wherein the control unit decides the reference position based on a position of the actuator when the predetermined parameter satisfies a second condition and stores the decided reference position.

5. The extreme ultraviolet light generation system according to claim 1, wherein the control unit calculates, as the predetermined parameter, a size of the target after irradiation with the prepulse laser beam and before irradiation with the main pulse laser beam, and
determines that the predetermined parameter does not satisfy the first condition if the size of the target is equal to or smaller than a first predetermined value.

6. The extreme ultraviolet light generation system according to claim 5, wherein the control unit determines that the predetermined parameter satisfies a second condition if the size of the target is equal to or larger than a second predetermined value larger than the first predetermined value,
decides the reference position based on the position of the actuator when the predetermined parameter satisfies the second condition, and stores the decided reference position.

7. The extreme ultraviolet light generation system according to claim 1, wherein the control unit calculates, as the predetermined parameter, an inclination of the target after irradiation with the prepulse laser beam and before irradiation with the main pulse laser beam, and
determines that the predetermined parameter does not satisfy the first condition if the inclination of the target is equal to or larger than a third predetermined value.

8. The extreme ultraviolet light generation system according to claim 7, wherein the control unit determines that the predetermined parameter satisfies a second condition if the inclination of the target is equal to or smaller than a fourth predetermined value smaller than the third predetermined value,
decides the reference position based on the position of the actuator when the predetermined parameter satisfies the second condition, and stores the decided reference position.

9. The extreme ultraviolet light generation system according to claim 1, further comprising a beam combiner configured to substantially match optical paths of the prepulse laser beam and the main pulse laser beam,
wherein the light focusing optical system is arranged in the optical paths of the prepulse laser beam and the main pulse laser beam emitted from the beam combiner, and
the actuator is configured to change a position of the light focusing optical system.

10. The extreme ultraviolet light generation system according to claim 1, further comprising:
a beam combiner configured to substantially match optical paths of the prepulse laser beam and the main pulse laser beam; and
a mirror arranged in the optical path of the prepulse laser beam between the prepulse laser and the beam combiner,
wherein the actuator is configured to change an orientation of the mirror.

11. An extreme ultraviolet light generation system comprising:
a target supply unit configured to output a target toward a predetermined region;
a prepulse laser configured to output a prepulse laser beam to be applied to the target in the predetermined region;
a main pulse laser configured to output a main pulse laser beam to be applied to the target irradiated with the prepulse laser beam in the predetermined region;
a light focusing optical system configured to focus the prepulse laser beam and the main pulse laser beam on the predetermined region;
an actuator configured to change a focusing position of the prepulse laser beam by the light focusing optical system;
a second sensor configured to detect light radiated from the predetermined region after the target is irradiated with the main pulse laser beam; and
a control unit configured to store a reference position of the actuator, obtain a predetermined parameter, control the actuator based on data obtained from the second sensor if the predetermined parameter satisfies a first condition, and control the actuator based on the reference position if the predetermined parameter does not satisfy the first condition.

12. The extreme ultraviolet light generation system according to claim 11, wherein the second sensor detects extreme ultraviolet light radiated from the predetermined region, and
the control unit calculates a gravity center position of a source of the extreme ultraviolet light based on the data obtained from the second sensor and controls the actuator based on the gravity center position.

13. The extreme ultraviolet light generation system according to claim 11, wherein the control unit decides the reference position based on a position of the actuator when the predetermined parameter satisfies a second condition and stores the decided reference position.

14. The extreme ultraviolet light generation system according to claim 13, wherein the control unit determines that the predetermined parameter satisfies the first condition if the predetermined parameter is larger than a first predetermined value, and
determines that the predetermined parameter satisfies the second condition if the predetermined parameter is equal to or larger than a second predetermined value larger than the first predetermined value.

15. The extreme ultraviolet light generation system according to claim 13, wherein the control unit determines that the predetermined parameter satisfies the first condition if the predetermined parameter is smaller than a third predetermined value, and
determines that the predetermined parameter satisfies the second condition if the predetermined parameter is equal to or smaller than a fourth predetermined value smaller than the third predetermined value.

16. The extreme ultraviolet light generation system according to claim 11, further comprising a beam combiner configured to substantially match optical paths of the prepulse laser beam and the main pulse laser beam,
wherein the light focusing optical system is arranged in the optical paths of the prepulse laser beam and the main pulse laser beam emitted from the beam combiner, and
the actuator is configured to change a position of the light focusing optical system.

17. The extreme ultraviolet light generation system according to claim 11, further comprising:
a beam combiner configured to substantially match optical paths of the prepulse laser beam and the main pulse laser beam, and
a mirror arranged in the optical path of the prepulse laser beam between the prepulse laser and the beam combiner,
wherein the actuator is configured to change an orientation of the mirror.
